(19) United States
(12) Patent Application Publication
(10) Pub. No.: US 2026/0197230 A1
(43) Pub. Date: Jul. 9, 2026

(54) CONFIGURATION MANAGEMENT API FOR OPERATION AND MAINTENANCE FUNCTIONS IN R1 INTERFACE

(71) Applicant: RAKUTEN MOBILE, INC., Tokyo (JP)

(72) Inventors: Pankaj Tanaji SHETE, Tokyo (JP); Awn MUHAMMAD, Tokyo (JP)

(73) Assignee: RAKUTEN MOBILE, INC., Tokyo (JP)

(21) Appl. No.: 18/868,268

(22) PCT Filed: Aug. 23, 2024
(86) PCT No.: PCT/US2024/043527

§ 371 Date: Nov. 22, 2024

Related U.S. Application Data
(60) Provisional application No. 63/565,200, filed on Mar. 14, 2024.

(30) Foreign Application Priority Data
Aug. 31, 2024 (IN) 202341058627

(51) Int. Cl. H04L 41/0803; H04L 41/0273; H04L 67/02

(52) U.S. Cl. CPC H04L 41/0803; H04L 41/0273; H04L 67/02

(57) ABSTRACT

A method, apparatus, and system for configuration management API's for radio access network (RAN) operation and maintenance (OAM) functions in R1 interface may be provided and may include, receiving, by an API producer, an HTTP request, wherein the HTTP request originates from an API consumer; determining, by the API producer, whether the HTTP request is valid or not based on whether the API consumer is authorized or not; based on determining that the HTTP request is valid, performing, by the API producer, a configuration management (CM) operation based on the HTTP request; and sending, by the API producer, an HTTP response based on the CM operation and whether the HTTP request is valid or not.

### FIELD

The present disclosure relates to a configuration management API for radio access network (RAN) operation and maintenance (OAM) functions in R1 interface.

### BACKGROUND

The information disclosed in this background section is only for enhancement of understanding of the general background of the disclosure and should not be taken as an acknowledgement or any form of suggestion that this information forms the prior art already known to a person skilled in the art.

A radio access network (RAN) is an important component in a telecommunications system, as it connects end-user devices (or user equipment) to other parts of the network. The RAN includes a combination of various network elements (NEs) that connect end-users to a core network. Traditionally, hardware and/or software of a particular RAN is vendor specific.

Open RAN (O-RAN) technology has emerged to enable multiple vendors to provide hardware and/or software to a telecommunications system. Since different vendors are involved, the type of hardware and/or software provided may also be different. That is, different types of NEs may be provided by different vendors, and depending on the specific service, the NE could be virtualized in software form (e.g., virtual machine (VM)-based), or could be in physical hardware form (e.g., non-VM based).

To this end, O-RAN disaggregates the RAN functions into a centralized unit (CU), a distributed unit (DU), and a radio unit (RU). The CU may be a logical node for hosting Radio Resource Control (RRC), Service Data Adaptation Protocol (SDAP), and/or Packet Data Convergence Protocol (PDCP) sublayers of the RAN. The DU may be a logical node hosting Radio Link Control (RLC), Media Access Control (MAC), and Physical (PHY) sublayers of the RAN. The RU may be a physical node that converts radio signals from antennas to digital signals that can be transmitted over the Front Haul to a DU. Because these entities have open protocols and interfaces between them, they can be developed by different vendors.

FIG. 1 illustrates an O-RAN architecture in the related art. RAN functions in the O-RAN architecture may be controlled and optimized by a RAN Intelligent Controller (RIC). The RIC may be a software-defined component that implements modular applications to facilitate the multivendor operability required in the O-RAN system, as well as to automate and optimize RAN operations. As shown in FIG. 1, the RIC may be divided into two types: a non-real-time RIC (Non-RT RIC) 120 and a near-real-time RIC (Near-RT RIC) 130.

The Non-RT RIC 120 may be the control point of a non-real-time control loop and may operate on a timescale greater than 1 second within a Service Management and Orchestration (SMO) framework 110. Its functionalities may be implemented through modular applications called rApps, and may include: providing policy based guidance and enrichment across the A1 interface, which is the interface that enables communication between the Non-RT RIC and the Near-RT RIC; performing data analytics; Artificial Intelligence/Machine Learning (AI/ML) training and inference for RAN optimization; and/or recommending configuration management actions over the O1 interface, which may be the interface that connects the SMO to RAN managed elements (e.g., Near-RT RIC 130, O-RAN Centralized Unit (O-CU) 140,150, O-RAN Distributed Unit (O-DU) 170, etc.).

The Near-RT RIC 130 may operate on a timescale between 10 milliseconds and 1 second and may be coupled with the O-DU 170, the O-CU (disaggregated into the O-CU control plane (O-CU-CP) 140 and the O-CU user plane (O-CU-UP) 150), and an open evolved NodeB (O-eNB) 160 via the E2 interface. The Near-RT RIC 130 may use the E2 interface to control the underlying RAN elements (E2 nodes/network functions (NFs)) over a near-real-time control loop. The Near-RT RIC 130 may monitor, suspend/stop, override, and control the E2 nodes (O-CU 140,150, O-DU 170, and O-eNB 160) via policies. For example, the Near-RT RIC 130 may set policy parameters on activated functions of the E2 nodes. Further, the Near-RT RIC 130 may host xApps to implement functions such as quality of service (QoS) optimization, mobility optimization, slicing optimization, interference mitigation, load balancing, security, etc.

Here, the O-CU-CP 140 and the O-CU-UP 150 may be coupled to each other via the E1 interface, and may be coupled to the O-DU 170 via the F1-c interface and F1-u interface, respectively. Further, the O-RU 180 may be coupled to the O-DU 170 via the Open Fronthaul (OF) Control (C), User (U), Synchronization(S), and Management (M) Planes, and may be coupled to the SMO 110 via the OF M-Plane.

The two types of RICs work together to optimize the O-RAN. For example, the Non-RT RIC 120 may provide the policies, data, and AI/ML models enforced and used by the Near-RT RIC 130 for RAN optimization, and the Near-RT RIC 130 may return policy feedback (i.e., how the policy set by the Non-RT RIC 120 works).

As mentioned above, the Non-RT RIC 120 may be located within the SMO framework 110, which manages and orchestrates RAN elements. Specifically, the SMO 110 may manage and orchestrate what is referred to as the O-RAN Cloud (O-Cloud) 190. The O-Cloud 190 may be a collection of physical RAN nodes that host the RICs, O-CUs, and O-DUs, the supporting software components (e.g., the operating systems and runtime environments), and the SMO 110 itself. In other words, the SMO 110 may manage the O-Cloud 190 from within. The O2 interface may be the interface between the SMO 110 and the O-Cloud 190 it resides in. Through the O2 interface, the SMO 110 may provide infrastructure management services (IMS) and deployment management services (DMS).

In the related art, an rApp in the Non-RT RIC 120 may implement Configuration Management (CM) services. The CM services may be produced by a CM service producer which performs logical RAN OAM (Operation and Maintenance)-related functions. The CM service may allow the service consumer to access configuration information which pertains to managed entities, as obtained by the CM service producer. The CM service may further allow the service consumer to request configuration changes related to the managed entities.

### SUMMARY

Methods used in the related art may not fully consider how to read and write CM data between an API producer and an API consumer. Features such as synchronous/asynchronous operation as well as subscriptions to CM jobs may not be fully considered. Accordingly, there is a need for a method which can incorporate the above.

According to embodiments, a method, apparatus, and system for radio access network (RAN) operation and maintenance (OAM) functions in R1 interface may be provided and may include, receiving, by an API producer, an HTTP request, wherein the HTTP request originates from an API consumer; determining, by the API producer, whether the HTTP request is valid or not based on whether the API consumer is authorized or not; based on determining that the HTTP request is valid, performing, by the API producer, a configuration management (CM) operation based on the HTTP request; and sending, by the API producer, an HTTP response based on the CM operation and whether the HTTP request is valid or not.

Based on the above embodiments, an optimized method for reading/writing CM data between an API producer and an API consumer may be achieved.

According to embodiments, an API producer may be provided, and may be configured to: receive an HTTP request, wherein the HTTP request originates from an API consumer; determine whether the HTTP request is valid based on whether the API consumer is authorized; based on determining that the HTTP request is valid, perform a configuration management (CM) operation based on the HTTP request; and send an HTTP response based on the CM operation and whether the HTTP request is valid.

According to embodiments, at least one non-transitory computer-readable recording medium having recorded thereon instructions executable to implement a method may be provided, the method including: receiving, by an API producer, an HTTP request, wherein the HTTP request originates from an API consumer; determining, by the API producer, whether the HTTP request is valid based on whether the API consumer is authorized; based on determining that the HTTP request is valid, performing, by the API producer a configuration management (CM) operation based on the HTTP request; and sending, by the API producer, an HTTP response based on the CM operation and whether the HTTP request is valid.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates an O-RAN architecture according to the related art;

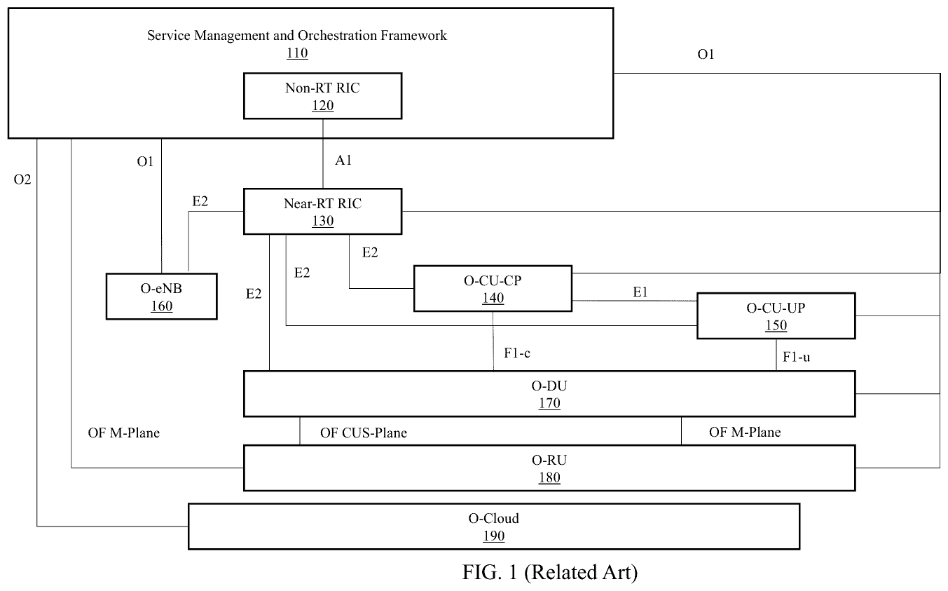

FIG. 2 illustrates a call flow diagram for writing to multiple nodes for a configuration change according to an embodiment;

FIG. 3 illustrates a call flow diagram for writing to a single 3GPP/O-RAN node for a configuration change according to an embodiment;

FIG. 4 illustrates a call flow diagram for reading to multiple nodes for a configuration change according to an embodiment;

FIG. 5 illustrates a call flow diagram for reading to a single 3GPP/O-RAN node for a configuration change according to an embodiment;

FIG. 6 illustrates an example method for performing CM operation based on HTTP requests according to an embodiment;

FIG. 7 is a diagram of an example environment in which systems and/or methods, described herein, may be implemented; and

FIG. 8 is a diagram of example components of a device according to an embodiment.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

According to embodiments, a method, apparatus, and system for radio access network (RAN) operation and maintenance (OAM) functions over R1 interface may be provided and may include, receiving, by an API producer, an HTTP request, wherein the HTTP request originates from an API consumer; determining, by the API producer, whether the HTTP request is valid or not based on whether the API consumer is authorized or not; based on determining that the HTTP request is valid, performing, by the API producer, a configuration management (CM) operation based on the HTTP request; and sending, by the API producer, an HTTP response based on the CM operation and whether the HTTP request is valid or not.

Based on the above embodiments, an optimized method for reading/writing CM data between an API producer and an API consumer may be achieved.

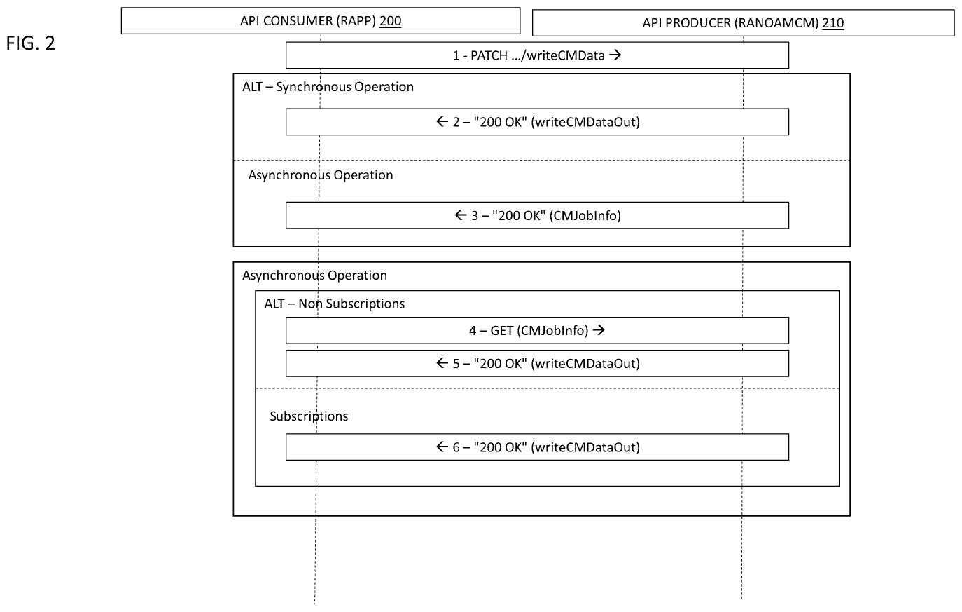

FIG. 2 illustrates a call flow diagram for writing to multiple nodes for a configuration change according to an embodiment.

As shown in FIG. 2, two cases of synchronous operation and asynchronous operation may be considered. API consumer 200 (which may operate as an rApp) may be provided, and API producer 210 (which may operate as a RAN OAM CM service) may be provided.

### Synchronous Operation

Referring to FIG. 2, at step 1, HTTP PATCH request may be sent by API consumer 200 to API producer 210. The HTTP PATCH request may include, for example, the rApp identifier, a list of node ID's with a segment of a Uniform Resource Identifier Local Distinguished Name (URI-LDN-first-part), and a class name ID. Upon receiving the HTTP PATCH request, API producer 210 may be configured to process the write configuration details received in the HTTP PATCH request and determine if the request sent by API consumer 200 is valid or not.

At step 2, API producer 210 may return an HTTP PATCH response. On success, a message indicating success (“200 OK”) may be returned, and the message content of the HTTP PATCH response may include the result of writing configuration data operation (e.g., “writeCMDataOut”). If the operation failed (e.g., the HTTP PATCH request was not valid), an error code may be returned in the HTTP PATCH response, and the response message content may include, for example, additional error information.

### Asynchronous Operation

The asynchronous operation may also further include sub-cases where the RAN OAM does not support subscribing to a CM job (or API consumer 200 has not subscribed to RAN OAM CM job), or does support subscription.

Step 1 in the asynchronous operation is the same as in the synchronous case above.

At step 3, the API producer 210 may return an HTTP PATCH response. On success, a message indicating success (“200 OK”) may be returned, and the response message content may carry information related to the CM job which was created by RAN OAM CM to write CM data over nodes. If the operation failed (e.g., the HTTP PATCH request was not valid), an error code may be returned in the HTTP PATCH response, and the response message content may include, for example, additional error information.

### CM Job Subscription Not Available

In the case subscription is not available, at step 4, API consumer 200 may send an HTTP GET request that includes an rApp identifier and a CM Job ID.

At step 5, API producer 210 may return another HTTP PATCH response. On success, a message indicating success (“200 OK”) may be returned, and the message content of the HTTP PATCH response may include the result of writing configuration data operation (e.g., “writeCMDataOut”). If the operation failed (e.g., the HTTP PATCH request was not valid), an error code may be returned in the HTTP PATCH response, and the response message content may include, for example, additional error information.

### CM Job Subscription Available

In the case subscription to RAN OAM CM by API consumer 200 is available, at step 6, after executing the write CM data operation over the nodes, the RAN OAM CM will carry a result of the write configuration data (e.g., “writeCMDataOut”) from API producer 210 to API consumer 200.

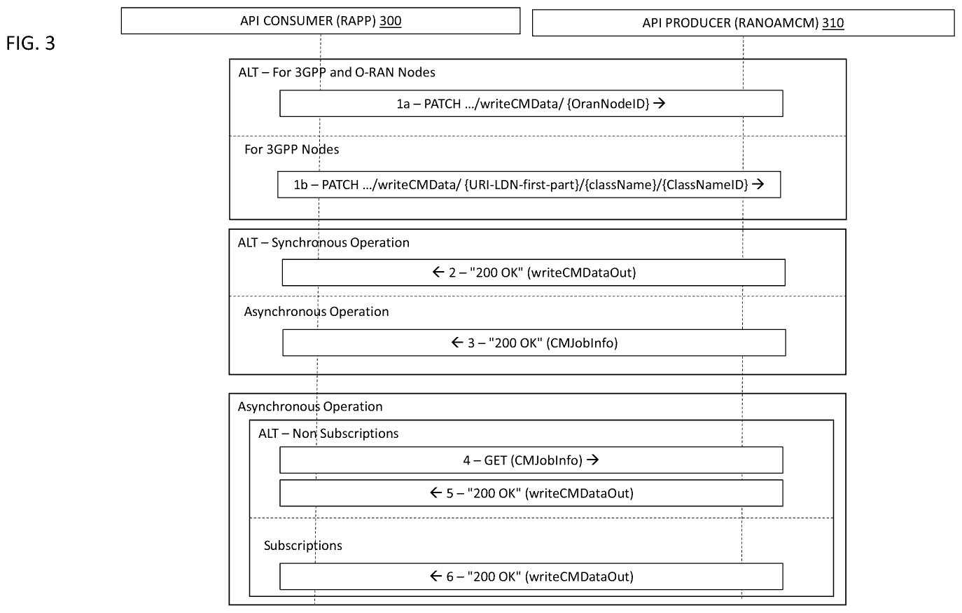

FIG. 3 illustrates a call flow diagram for writing to a single 3GPP/O-RAN node for a configuration change according to an embodiment.

As shown in FIG. 3, two cases of synchronous operation and asynchronous operation may be considered. API consumer 300 (which may operate as an rApp) may be provided, and API producer 310 (which may operate as a RAN OAM CM service) may be provided.

### Synchronous Operation

Referring to FIG. 3, at step 1a, wherein the node is 3rd Generation Partnership Project (3GPP) or ORAN, HTTP PATCH request may be sent by API consumer 300 to API producer 310. The HTTP PATCH request should include ORAN Node ID for ORAN or 3GPP Nodes. Upon receiving the HTTP PATCH request, API producer 310 may be configured to process the write configuration details received in the HTTP PATCH request and determine if the request sent by API consumer 300 is valid or not.

Alternative to step 1a wherein the node is 3GPP, at step 1b, HTTP PATCH request may be sent by API consumer 300 to API producer 310. The HTTP PATCH request should include rApp identifier, node id with URI-LDN-first-part, Class name ID for 3GPP Node. Upon receiving the HTTP PATCH request, API producer 310 may be configured to process the write configuration details received in the HTTP PATCH request and determine if the request sent by API consumer 300 is valid or not.

At step 2, API producer 310 may return an HTTP PATCH response. On success, a message indicating success (“200 OK”) may be returned, and the message content of the HTTP PATCH response may include the result of writing configuration data operation (e.g., “writeCMDataOut”). If the operation failed (e.g., the HTTP PATCH request was not valid), an error code may be returned in the HTTP PATCH response, and the response message content may include, for example, additional error information.

### Asynchronous Operation

The asynchronous operation may also further include sub-cases where the RAN OAM does not support subscribing to a CM job (or API consumer 300 has not subscribed to RAN OAM CM job), or does support subscription.

Step 1 in the asynchronous operation is the same as in the synchronous case above.

At step 3, the API producer 310 may return an HTTP PATCH response. On success, a message indicating success (“200 OK”) may be returned, and the response message content may carry information related to the CM job which was created by RAN OAM CM to write CM data over nodes. If the operation failed (e.g., the HTTP PATCH request was not valid), an error code may be returned in the HTTP PATCH response, and the response message content may include, for example, additional error information.

### CM Job Subscription not Available

In the case subscription is not available, at step 4, API consumer 300 may send an HTTP GET request that includes an rApp identifier and a CM Job ID.

At step 5, API producer 310 may return another HTTP PATCH response. On success, a message indicating success (“200 OK”) may be returned, and the message content of the HTTP PATCH response may include the result of writing configuration data operation (e.g., “writeCMDataOut”). If the operation failed (e.g., the HTTP PATCH request was not valid), an error code may be returned in the HTTP PATCH response, and the response message content may include, for example, additional error information.

### CM Job Subscription Available

In the case subscription to RAN OAM CM by API consumer 300 is available, at step 6, after executing the write CM data operation over the nodes, the RAN OAM CM will carry a result of the write configuration data (e.g., “writeCMDataOut”) from API producer 310 to API consumer 300.

### Resource Definitions

The example embodiments illustrated in FIGS. 2 and 3 for write CM may have resources defined as follows.

According to embodiments, the service registration API MAJOR version field may be 0, the MINOR version field may be 0 and the PATCH version field may be 0 (see clause 9.1 of ETSI GS NFV-SOL 013 [4] for a definition of the version fields). Consequently, the <apiMajor Version> URI variable may be set to “v0”.

For URI structures, two options may be used.

According to a first case, only 3rd Generation Partnership Project (3GPP) nodes may be used (e.g., the distributed unit (DU) and central unit (CU)). In this scenario, the URI may have a structure as follows:

```
{apiRoot}/ranoamcm/<apiMajorversion
/ WriteCMData
  / URI-LDN
    /{ URI-LDN-first-part }
      / {className}
        {classNameID}
```

For the case of writing configuration changes to multiple nodes (such as illustrated in FIG. 2), . . . /WriteCMData may be included in the PATCH request.

For the case of writing configuration changes to a single node (such as illustrated in FIG. 3), a URI of . . . /WriteCMData/URI-LDN/{URI-LDN-first-part}/{className}/{classNameID} may be included in the PATCH request.

According to a second case, both ORAN and 3GPP nodes may be used. In this scenario, the <apiName> resource URI variable may be “ranoamcm”. The URI may have a structure as follows:

{apiRoot}/ranoamcm/<apiMajorversion
/ WriteCMData
/ {OranNodeID}

For the case of writing configuration changes to multiple nodes (such as illustrated in FIG. 2), . . . /WriteCMData may be included in the PATCH request.

For the case of writing configuration changes to a single node (such as illustrated in FIG. 3), a URI of . . . //WriteCMData/{OranNodeID} may be included in the PATCH request.

In general, a Resource URI may be given by the format: {apiRoot}/ranoamcm/<apiMajorVersion>/writeCMData.

In general, for 3GPP node, the Resource URI may be {apiRoot}/ranoamcm/<apiMajorVersion>/WriteCMData/URI-LDN/{URI-LDN-first-part}/{className}/{classNameID}

In general, for 3GPP and O-RAN node, the resource URI may be: {apiRoot}/ranoamcm/<apiMajorVersion>/WriteCMData/{OranNodeID}

className may refer to the Class name of the targeted resource

classNameID may refer to Identifier of the targeted resource

OranNodeID may refer to Identifier of the targeted O-RAN node. However, it should be noted that if O-RAN Nodes are O-CU, O-DU then URI-LDN is to be used (see 4.4.2 of TS 32.158 [15]). If O-RAN Nodes are O-RU, then relevant IDs to identify O-RU to be used such as ru-instance-id (see 10.1.2. of O-RAN.WG5.O-DU-O1)

Other example tables indicating resource names and descriptions are given by the below:

TABLE 1
Data structures supported by the PATCH request body on this resource

| Data type | P | Cardinality | Description |
|---|---|---|---|
| array(writeCMData) | 1. M | 1 | Patch document describing the set of |
| | | | modifications to be applied to the targeted |
| | | | resources. |
| | | | The following patch media types are available: |
| | | | “application/merge-patch + json” (RFC |
| | | | 7396 [37]) |
| | | | “application/3gpp-merge-patch + json” |
| | | | (TS 32.158 [15]) |
| | | | “application/json-patch + json” (RFC |
| | | | 6902 [36]) |
| | | | “application/3gpp-json-patch + json” |
| | | | (TS 32.158 [15]) |

TABLE 2
Data structures supported by the PATCH Response Body on this resource

| | | | Response | |
|---|---|---|---|---|
| Data type | P | Cardinality | codes | Description |
| CMJobInfo | C | 1 | 200 OK | Write CM Request has been |
| | | | | validated successfully and CM |
| | | | | changes over Nodes ongoing. |
| array(writeCMDataOut) | 2. C | 1 | 200 OK | The operation was successful. |
| | | | | Refer |
| ProblemDetails | 3. O | 0 . . . 1 | 4xx/5xx | Detail problem description |

TABLE 3
Data structures supported by the PATCH Response Body on this resource

| | | | Response | |
|---|---|---|---|---|
| Data type | P | Cardinality | codes | Description |
| WriteCMJobInfo | C | 1 | 200 OK | In the case of Asynchronous |
| | | | | Write CM Request has been |
| | | | | validated successfully and CM |
| | | | | changes over Nodes ongoing. |
| | | | | Information related to Job created |
| | | | | by RAN OAM for writing CM |
| | | | | changes towards O-RAN Nodes. |
| | | | | Which rApp can use to query |
| | | | | status of WriteCMJob. |
| array(writeCMDataOut) | 4. C | 1 | 200 OK | In the case of synchronous |
| | | | | operations, it was successful. |
| | | | | Refer |
| ProblemDetails | 5. O | 0 . . . 1 | 4xx/5xx | Detail problem description |

C: WriteCMJobInfo is Mandatory services operation is Asynchronous otherwise optional:writeCMDataOut is Mandatory services operation is synchronous otherwise optional.

TABLE 4
Simple data types and enumerations

| | Type | |
|---|---|---|
| Type name | definition | Description |
| WriteCMJobInfo | String | Details related to CM Job created by RAN |
| | | OAM for writing CM changes over |
| | | Nodes. |
| | | rApp to use same information to query |
| | | result of CM write changes over Nodes. |

TABLE 5
writeCMData

| Attribute Name | Data type | P | Cardinality | Description |
|---|---|---|---|---|
| oranNodeID | String | M | 1 | Identifier of the RAN node |
| | | | | If O-RAN Nodes are O-CU, O- |
| | | | | DU then URI-LDN to be used see |
| | | | | 4.4.2 of 3GPP TS 32.158 [15] |
| | | | | If O-RAN Nodes is O-RU, then |
| | | | | relevant IDs to identify O-RU to |
| | | | | be used such as ru-instance-id see |
| | | | | 10.1.2. of O-RAN.WG5.O-DU- |
| | | | | O1 [ ] |
| Array(resource) | Resource | C | 1 | Resources identified in the request for |
| | | | | retrieval containing the attributes |
| | | | | specified in the query parameters. |
| | | | | See 3GPP TS 28.532, clause |
| | | | | 12.1.1.3.2.1.3-2 |
| Array(PatchItem) | PatchItem | C | 1 | See 3GPP TS 28.532, clause |
| | | | | 12.1.1.4.1a.9 |

Inclusion of resource or PatchItem depends on type of PATCH Operation
“application/merge-patch + json” (RFC 7396 [37]), request body type: Resource
“application/vnd.3gpp.merge-patch + json” (TS 32.158 [15]), request body type: Resource
“application/json-patch + json” (RFC 6902 [36]), request body type: array(PatchItem)
“application/vnd.3gpp.json-patch + json” (TS 32.158 [15]), request body type: array(PatchItem)

TABLE 6
writeCMDataOut

| Attribute Name | Data type | P | Cardinality | Description |
|---|---|---|---|---|
| oranNodeID | String | M | 1 | Identifier of the RAN node |
| | | | | If O-RAN Nodes are O-CU, O- |
| | | | | DU then URI-LDN to be used see |
| | | | | 4.4.2 of 3GPP TS 32.158 [15] |
| | | | | If O-RAN Nodes is O-RU, then |
| | | | | relevant IDs to identify O-RU to |
| | | | | be used such as ru-instance-id see |
| | | | | 10.1.2. of O-RAN.WG5.O-DU- |
| | | | | O1 [ ] |
| Array(resource) | Resource | C | 1 | Resources identified in the request for |
| | | | | retrieval containing the attributes |
| | | | | specified in the query parameters. |
| | | | | See 3GPP TS 28.532, clause |
| | | | | 12.1.1.3.2.1.3-2 |
| eventTime | DateTime | C | 0 . . . 1 | Event (CM Change) occurrence time |

It should be appreciated that the above tables are examples of data structures which can be used and other data structures/resource structures may be used by a person skilled in the art.

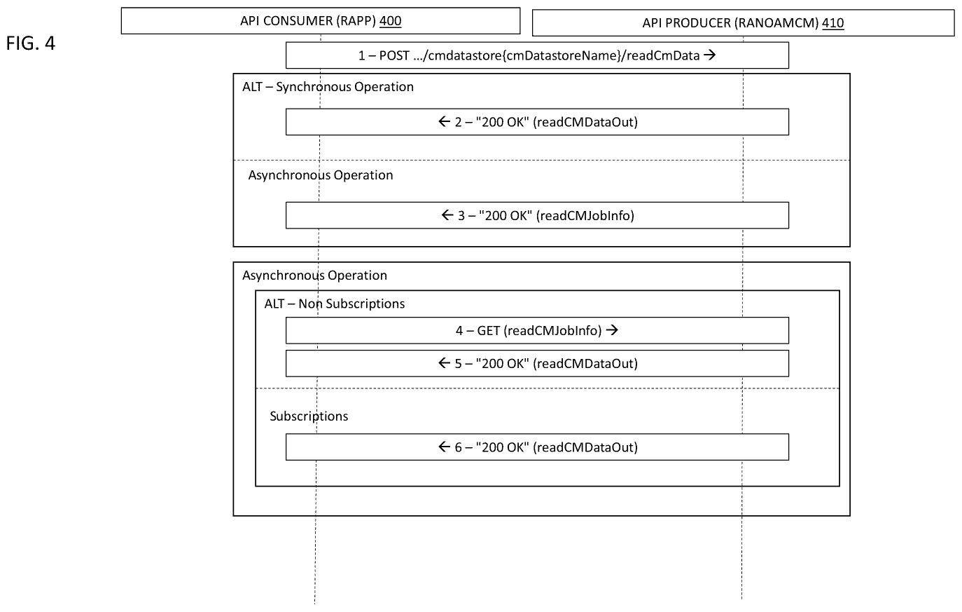

FIG. 4 illustrates a call flow diagram for reading to multiple nodes for a configuration change according to an embodiment.

As shown in FIG. 4, two cases of synchronous operation and asynchronous operation may be considered. API consumer 400 (which may operate as an rApp) may be provided, and API producer 410 (which may operate as a RAN OAM CM service) may be provided.

### Synchronous Operation

Referring to FIG. 4, at step 1, HTTP POST request may be sent by API consumer 400 to API producer 410. The HTTP POST request may include, for example, the rApp identifier, a list of node ID's with a segment of a Uniform Resource Identifier Local Distinguished Name (URI-LDN-first-part), and a class name ID. Upon receiving the HTTP POST request, API producer 410 may be configured to process the read configuration details received in the HTTP POST request and determine if the request sent by API consumer 400 is valid or not.

At step 2, API producer 410 may return an HTTP POST response. On success, a message indicating success (“200 OK”) may be returned, and the message content of the HTTP POST response may include the result of reading configuration data operation (e.g., “readCMDataOut”). If the operation failed (e.g., the HTTP POST request was not valid), an error code may be returned in the HTTP POST response, and the response message content may include, for example, additional error information.

### Asynchronous Operation

The asynchronous operation may also further include sub-cases where the RAN OAM does not support subscribing to a CM job (or API consumer 400 has not subscribed to RAN OAM CM job), or does support subscription.

Step 1 in the asynchronous operation is the same as in the synchronous case above.

At step 3, the API producer 410 may return an HTTP POST response. On success, a message indicating success (“200 OK”) may be returned, and the response message content may carry information related to the CM job which was created by RAN OAM CM to read CM data over nodes. If the operation failed (e.g., the HTTP POST request was not valid), an error code may be returned in the HTTP POST response, and the response message content may include, for example, additional error information.

### CM Job Subscription not Available

In the case subscription is not available, at step 4, API consumer 400 may send an HTTP GET request that includes an rApp identifier and a CM Job ID.

At step 5, API producer 410 may return another HTTP POST response. On success, a message indicating success (“200 OK”) may be returned, and the message content of the HTTP POST response may include the result of reading configuration data operation (e.g., “readCMDataOut”). If the operation failed (e.g., the HTTP POST request was not valid), an error code may be returned in the HTTP POST response, and the response message content may include, for example, additional error information.

### CM Job Subscription Available

In the case subscription to RAN OAM CM by API consumer 400 is available, at step 6, after executing the read CM data operation over the nodes, the RAN OAM CM will carry a result of the read configuration data (e.g., “readCMDataOut”) from API producer 410 to API consumer 400.

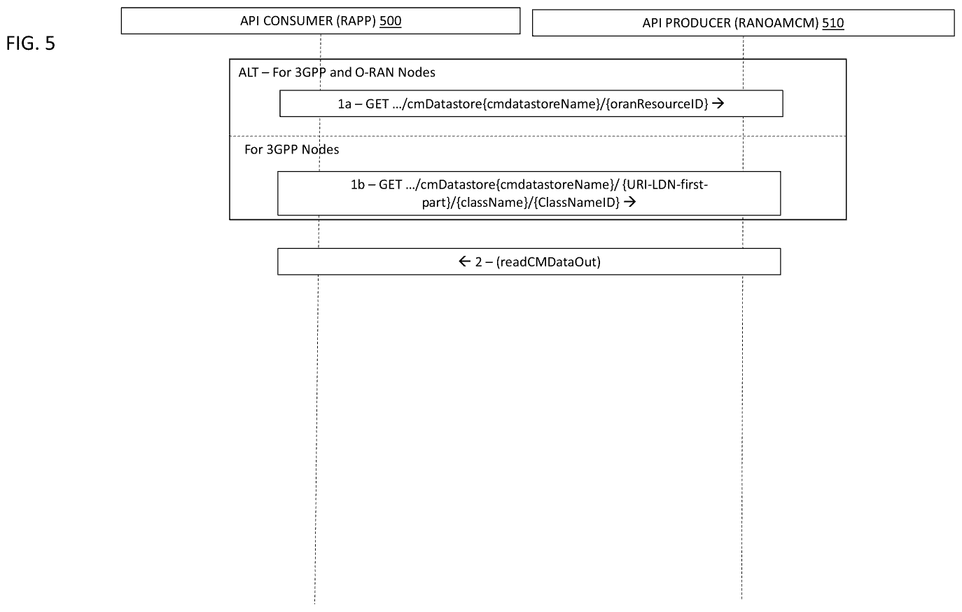

FIG. 5 illustrates a call flow diagram for reading to a single 3GPP/O-RAN node for a configuration change according to an embodiment.

API consumer 500 (which may operate as an rApp) may be provided, and API producer 510 (which may operate as a RAN OAM CM service) may be provided.

Referring to FIG. 5, at step 1a, wherein the node is 3rd Generation Partnership Project (3GPP) or ORAN, HTTP GET request may be sent by API consumer 500 to API producer 510. The HTTP GET request should include oranResourceID for ORAN or 3GPP Nodes. Upon receiving the HTTP GET request, API producer 510 may be configured to process the read configuration details received in the HTTP GET request and determine if the request sent by API consumer 500 is valid or not.

Alternative to step 1a wherein the node is 3GPP, at step 1b, HTTP GET request may be sent by API consumer 500 to API producer 510. The HTTP GET request should include rApp identifier, node id with URI-LDN-first-part, Class name ID, and optional query data for 3GPP Node. Upon receiving the HTTP GET request, API producer 510 may be configured to process the read configuration details received in the HTTP GET request and determine if the request sent by API consumer 500 is valid or not.

At step 2, API producer 510 may return an HTTP GET response. On success, a message indicating success (“200 OK”) may be returned, and the message content of the HTTP GET response may include the result of writing configuration data operation (e.g., “readCMDataOut”). If the operation failed (e.g., the HTTP GET request was not valid), an error code may be returned in the HTTP GET response, and the response message content may include, for example, additional error information.

### Resource Definitions

The example embodiments illustrated in FIGS. 4 and 5 for read CM may have resources defined as follows.

According to embodiments, the service registration API MAJOR version field may be 0, the MINOR version field may be 0 and the PATCH version field may be 0 (see clause 9.1 of ETSI GS NFV-SOL 013 [4] for a definition of the version fields). Consequently, the <apiMajor Version> URI variable may be set to “v0”.

For URI structures, two options may be used.

According to a first case, only 3rd Generation Partnership Project (3GPP) nodes may be used (e.g., the distributed unit (DU) and central unit (CU)). In this scenario, the URI may have a structure as follows:

```
{apiRoot}/ranoamcm/Datastore/{datastoreName}
/ WriteCMData
  / URI-LDN
    / { URI-LDN-first-part }
      / {className}
        / {classNameID}
```

For the case of reading configuration changes from multiple nodes (such as illustrated in FIG. 4), . . . /Datastore/{datastoreName} may be included in the POST request.

For the case of writing configuration changes to a single node (such as illustrated in FIG. 5), a URI of . . . /Datastore/{datastoreName}/URI-LDN/{URI-LDN-first-part}/{className}/{classNameID} may be included in the GET request.

According to a second case, both ORAN and 3GPP nodes may be used. In this scenario, the <apiName> resource URI variable may be “ranoamcm”. The URI may have a structure as follows:

{apiRoot}/ranoamcm/<apiMajorversion/ cmDatastore/{cmdatastoreName}
/ { oranResourceID }

For the case of reading configuration changes to multiple nodes (such as illustrated in FIG. 5), . . . /Datastore/{cmdatastoreName} may be included in the POST request.

For the case of reading configuration changes to a single node (such as illustrated in FIG. 5), a URI of . . . /Datastore/{cmdatastoreName}/{oranResourceID} may be included in the GET request.

cmdatastoreNam is a CM Datastore to be maintained by RAN OAM Function used for reading and writing configurations. There may be 2 data stores namely “readCMDataStore” and “readCMDataStore”. For reading CM data, rApp may use “readCMDataStore”, Which is to be used for maintaining configuration data for northbound management entities and shall be synced with nodes periodically.

In general, a Resource URI may be given by the format: {apiRoot}/ranoamcm/<apiMajorVersion>/cmDatastore/{cmdatastoreName}.

In general, for 3GPP node, the Resource URI may be {apiRoot}/ranoamcm/<apiMajorVersion>/cmDatastore/{cmdatastoreName}/{oranResourceID}

In general, for 3GPP and O-RAN node, the resource URI may be: {apiRoot}/ranoamcm/<apiMajorVersion>/WriteCMData/{OranNodeID} className may refer to the Class name of the targeted resource

classNameID may refer to Identifier of the targeted resource

oranResourceID may refer to Identifier of the targeted O-RAN node. However, it

should be noted that if O-RAN Nodes are O-CU, O-DU then URI-LDN is to be used (see 4.4.2 of TS 32.158 [15]) as oranResourceID. If O-RAN Nodes are O-RU, then be the URI-ORAN-Resource which may consist of identifier and resource path as (a) identifier-root element of the m-plane model (yang) instance data tree or (b) resource-path: xpath of O-RU resource as defined by a node yang model

Other example tables indicating resource names and descriptions are given by the below:

TABLE 7
Data structures supported by the POST
request body on this resource

| Data type | P | Cardinality | Description |
|---|---|---|---|
| array(readCMData) | 6. M | 1 | Information related list of |
| | | | nodes, attributes or fields |
| | | | whose values to be retrieved. |

TABLE 8
Data structures supported by the POST Response Body on this resource

| | | | Response | |
|---|---|---|---|---|
| Data type | P | Cardinality | codes | Description |
| CMJobInfo | C | 1 | 200 OK | Read CM Request has been validated |
| | | | | successfully and Read CM data over |
| | | | | Nodes is processing. |
| array(readCMDataOut) | C | 1 | 200 OK | The operation was successful. |
| | | | | Refer |
| ProblemDetails | O | 0 . . . 1 | 4xx/5xx | Detail problem description |

TABLE 9
Data structures supported by the GET Response Body on this resource

| | | | Response | |
|---|---|---|---|---|
| Data type | P | Cardinality | codes | Description |
| array(readCMDataOut) | C | 1 | 200 OK | In the case of synchronous operations, |
| | | | | it was successful. |
| | | | | Refer |
| ProblemDetails | O | 0 . . . 1 | 4xx/5xx | Detail problem description |

C: ReadCMJobInfo is Mandatory services operation is Asynchronous otherwise optional:readCMDataOut is Mandatory services operation is synchronous otherwise optional.

TABLE 10
Simple data types and enumerations

| | Type | |
|---|---|---|
| Type name | definition | Description |
| ReadCMJobInfo | String | Details related to CM Job created by RAN |
| | | OAM for writing CM changes over |
| | | Nodes. |
| | | rApp to use same information to query |
| | | result of CM read changes over Nodes. |

TABLE 11
readCMData

| Attribute Name | Data type | P | Cardinality | Description |
|---|---|---|---|---|
| oranResourceID | String | M | 1 | Identifier of the RAN node |
| | | | | If O-RAN Nodes are O-CU, O- |
| | | | | DU then URI-LDN to be used see |
| | | | | 4.4.2 of 3GPP TS 32.158 [15] |
| | | | | If O-RAN Nodes is O-RU, then |
| | | | | relevant IDs to identify O-RU to |
| | | | | be used such as ru-instance-id see |
| | | | | 10.1.2. of O-RAN.WG5.O-DU- |
| | | | | O1 [ ] |
| Array(resource) | Resource | C | 1 | Resources identified in the request for |
| | | | | retrieval containing the attributes |
| | | | | specified in the query parameters. |
| | | | | See 3GPP TS 28.532, clause |
| | | | | 12.1.1.3.2.1.3-2 |
| Attribute Name | Data type | P | Cardinality | See 3GPP TS 28.532, clause |
| | | | | 12.1.1.4.1a.9 |

oranResourceID

TABLE 12
readCMDataOut

| Attribute Name | Data type | P | Cardinality | Description |
|---|---|---|---|---|
| oranResourceID | String | M | 1 | Identifier of the RAN node |
| | | | | If O-RAN Nodes are O-CU, O- |
| | | | | DU then URI-LDN to be used see |
| | | | | 4.4.2 of 3GPP TS 32.158 [15] |
| | | | | If O-RAN Nodes is O-RU, then |
| | | | | relevant IDs to identify O-RU to |
| | | | | be used such as ru-instance-id see |
| | | | | 10.1.2. of O-RAN.WG5.O-DU- |
| | | | | O1 [ ] |
| Array(resource) | Resource | C | 1 | Resources identified in the request for |
| | | | | retrieval containing the attributes |
| | | | | specified in the query parameters. |
| | | | | See 3GPP TS 28.532, clause |
| | | | | 12.1.1.3.2.1.3-2 |
| Attribute Name | Data type | P | Cardinality | Description |

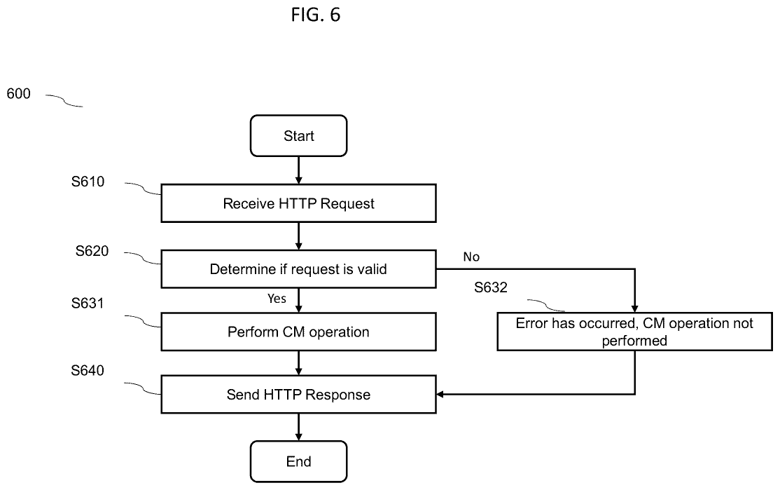

FIG. 6 illustrates an example method 600 for performing CM operation based on HTTP requests according to an embodiment.

At operation S610, a HTTP request may be received by an API producer originating from an API consumer. The HTTP request may be, for example, any of the HTTP PATCH/POST/GET requests as described with respect to FIG. 2-5 above.

At operation S620, the HTTP request received in S610 is determined by the API producer as to whether it is valid or not.

At operation S631, if it was determined in operation S620 that the HTTP request is valid, the CM operation is performed based on the HTTP request. The CM operation may be one of those described with respect to FIG. 2-5 above.

Alternative to operation S631, at operation S632, if it was determined in operation S620 that the HTTP request is not valid, an error has occurred. According to embodiments, an error message may be included in the HTTP response.

At operation S640, a HTTP response is sent based on the CM operation and whether the HTTP request is valid or not.

Based on the above embodiments, an optimized method for reading/writing CM data between an API producer and an API consumer may be achieved.

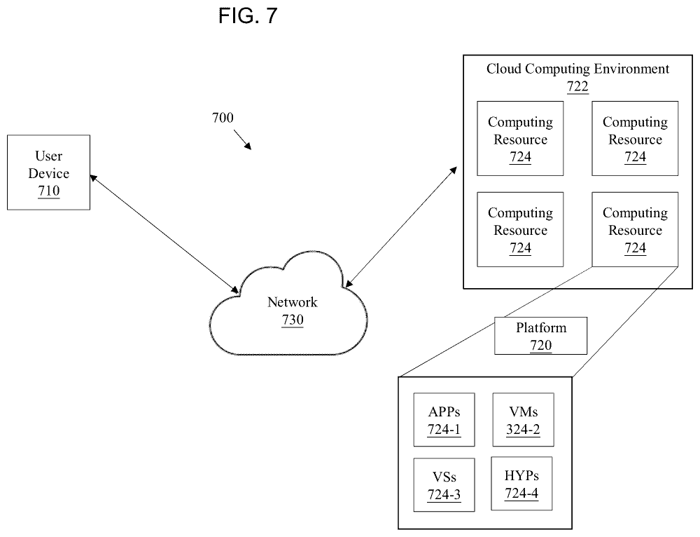

FIG. 7 is a diagram of an example environment 700 in which systems and/or methods, described herein, may be implemented. As shown in FIG. 7, environment 700 may include a user device 710, a platform 720, and a network 730. Devices of environment 700 may interconnect via wired connections, wireless connections, or a combination of wired and wireless connections. In embodiments, any of the functions and operations described with reference to FIGS. 2-6 above may be performed by any combination of elements illustrated in FIG. 7.

User device 710 includes one or more devices capable of receiving, generating, storing, processing, and/or providing information associated with platform 720. For example, user device 710 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 710 may receive information from and/or transmit information to platform 720.

Platform 720 includes one or more devices capable of receiving, generating, storing, processing, and/or providing information. In some implementations, platform 720 may include a cloud server or a group of cloud servers. In some implementations, platform 720 may be designed to be modular such that certain software components may be swapped in or out depending on a particular need. As such, platform 720 may be easily and/or quickly reconfigured for different uses.

In some implementations, as shown, platform 720 may be hosted in cloud computing environment 722. Notably, while implementations described herein describe platform 720 as being hosted in cloud computing environment 722, in some implementations, platform 720 may not be cloud-based (i.e., may be implemented outside of a cloud computing environment) or may be partially cloud-based.

Cloud computing environment 722 includes an environment that hosts platform 720. Cloud computing environment 722 may provide computation, software, data access, storage, etc., services that do not require end-user (e.g., user device 710) knowledge of a physical location and configuration of system(s) and/or device(s) that hosts platform 720. As shown, cloud computing environment 722 may include a group of computing resources 724 (referred to collectively as “computing resources 724” and individually as “computing resource 724”).

Computing resource 724 includes one or more personal computers, a cluster of computing devices, workstation computers, server devices, or other types of computation and/or communication devices. In some implementations, computing resource 724 may host platform 720. The cloud resources may include compute instances executing in computing resource 724, storage devices provided in computing resource 724, data transfer devices provided by computing resource 724, etc. In some implementations, computing resource 724 may communicate with other computing resources 724 via wired connections, wireless connections, or a combination of wired and wireless connections.

As further shown in FIG. 7, computing resource 724 includes a group of cloud resources, such as one or more applications (“APPs”) 724-1, one or more virtual machines (“VMs”) 724-2, virtualized storage (“VSs”) 724-3, one or more hypervisors (“HYPs”) 724-4, or the like.

Application 724-1 includes one or more software applications that may be provided to or accessed by user device 710. Application 724-1 may eliminate the need to install and execute the software applications on user device 710. For example, application 724-1 may include software associated with platform 720 and/or any other software capable of being provided via cloud computing environment 722. In some implementations, one application 724-1 may send/receive information to/from one or more other applications 724-1, via virtual machine 724-2.

Virtual machine 724-2 includes a software implementation of a machine (e.g., a computer) that executes programs like a physical machine. Virtual machine 724-2 may be either a system virtual machine or a process virtual machine, depending upon use and degree of correspondence to any real machine by virtual machine 724-2. A system virtual machine may provide a complete system platform that supports execution of a complete operating system (“OS”). A process virtual machine may execute a single program, and may support a single process. In some implementations, virtual machine 724-2 may execute on behalf of a user (e.g., user device 710), and may manage infrastructure of cloud computing environment 722, such as data management, synchronization, or long-duration data transfers.

Virtualized storage 724-3 includes one or more storage systems and/or one or more devices that use virtualization techniques within the storage systems or devices of computing resource 724. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 724-4 may provide hardware virtualization techniques that allow multiple operating systems (e.g., “guest operating systems”) to execute concurrently on a host computer, such as computing resource 724. Hypervisor 724-4 may present a virtual operating platform to the guest operating systems and may manage the execution of the guest operating systems. Multiple instances of a variety of operating systems may share virtualized hardware resources.

Network 730 includes one or more wired and/or wireless networks. For example, network 730 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 7 are provided as an example. In practice, there may be additional devices and/or networks, fewer devices and/or networks, different devices and/or networks, or differently arranged devices and/or networks than those shown in FIG. 7. Furthermore, two or more devices shown in FIG. 7 may be implemented within a single device, or a single device shown in FIG. 7 may be implemented as multiple, distributed devices. Additionally, or alternatively, a set of devices (e.g., one or more devices) of environment 700 may perform one or more functions described as being performed by another set of devices of environment 700.

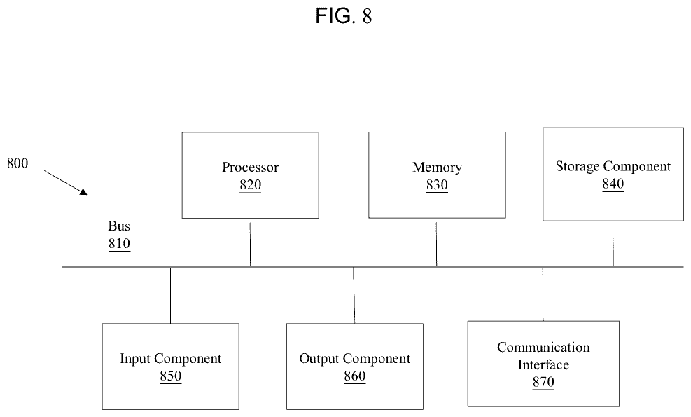

FIG. 8 illustrates an embodiment of a device 800. As shown in FIG. 8, the device 800 processor 810, a memory 820, a storage component 830, an input component 840, an output component 850, a communication interface 860, and a bus 870.

The processor 810, as used herein, means any type of computational circuit that may comprise hardware elements and software elements. The processor 810 may be embodied as a multi-core processor, a single core processor, or a combination of one or more multi-core processors and/or one or more single core processors, a distributed processing system, or the like. The processor 810 may be a Central Processing Unit (CPU) a graphics processing unit (GPU), an accelerated processing unit (APU), an application-specific integrated circuit (ASIC), or another type of processing component.

Memory 820 includes a non-transitory computer readable medium. Memory 820 includes a random-access memory (RAM), a read only memory (ROM), and/or another type of dynamic or static storage device (e.g., a flash memory, a magnetic memory, and/or an optical memory) that stores information and/or instructions for use by processor 810. The memory 820 comprises machine-readable instructions which are executable by the processor 810. These machine-readable instructions when executed by the processor 810 cause the processor 810 to perform one or more method steps of an embodiment described above.

Storage component 830 stores information and/or software related to the operation and use of the device 800. For example, storage component 830 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 840 is configured to receive information, such as user input. For example, the input component 840 may include, but not be limited to, a touch screen display, a keyboard, a keypad, a mouse, a button, a switch, and/or a microphone. Additionally, or alternatively, the input component 840 may include a sensor for sensing information (e.g., a global positioning system (GPS), an accelerometer, a gyroscope, and/or an actuator).

Output component 850 is configured to provide output information from the device 800. For example, the output component 850 may be, but not limited to, a display, a speaker, instructions to an external device, and/or one or more light-emitting diodes (LEDs).

Communication interface 860 is an interface that provides a communication connection to other devices, such as external devices and internal devices. The connection by the communication interface 860 can be a wired connection, a wireless connection, or a combination of wired and wireless connections, and can be a direct connection or an indirect connection via a communication network that exists between the device 800 and other devices. In other words, the standard of the communication interface 860 is not limited.

The bus 870 acts as an interconnect between the processor 810, the memory 820, the storage component 830, the input component 840, the output component 850, and the communication interface 860 of the device 800. The bus 870 may include a wired interconnection or a wireless interconnection.

The number and arrangement of components shown in FIG. 8 are provided as an example. In practice, device 800 may include additional components, fewer components, different components, or differently arranged components than those shown in FIG. 8. Additionally, or alternatively, a set of components (e.g., one or more components) of device 800 may perform one or more functions described as being performed by another set of components of device 800. Further, one or more method steps described in any of the embodiments may be performed utilizing a plurality of devices 800 in communication with one another.

In embodiments, any one of the operations or processes of FIGS. 2-6 may be implemented by or using any one of the elements illustrated in FIGS. 7 and 8. It is understood that other embodiments are not limited thereto, and may be implemented in a variety of different architectures (e.g., bare metal architecture, any cloud-based architecture or deployment architecture such as Kubernetes, Docker, OpenStack, etc.).

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Various further respective aspects and features of embodiments of the present disclosure may be defined by the following items:

Item [1]: A method including: receiving, by an API producer, an HTTP request, wherein the HTTP request originates from an API consumer; determining, by the API producer, whether the HTTP request is valid or not based on whether the API consumer is authorized or not; based on determining that the HTTP request is valid, performing, by the API producer, a configuration management (CM) operation based on the HTTP request; and sending, by the API producer, an HTTP response based on the CM operation and whether the HTTP request is valid or not.

Item [2]: A method according to Item [1], wherein the CM operation is a write configuration data operation, wherein the HTTP request is a HTTP PATCH request including details for the write configuration data operation, and wherein the HTTP response is a HTTP PATCH response, wherein if a single 3GPP node is used for the write configuration data operation, the details for the read configuration data operation include an rApp Identifier, a list of node identifiers (ID's) with a segment of a Uniform Resource Identifier Local Distinguished Name (URI-LDN-first-part), a class name identifier, optional query criteria, and an Open Radio Access Network (O-RAN) node identifier, wherein if a single O-RAN node is used for the write configuration data operation, the details for the read configuration data operation includes the O-RAN node ID, wherein if the write configuration data operation is synchronous, the HTTP PATCH Response includes a result of the write configuration data operation, and wherein if the write configuration data operation is asynchronous, the HTTP PATCH response includes data related to a write configuration management (CM) job for the write configuration data operation.

Item [3]: The method according to Item [2], wherein if the write configuration data operation is asynchronous, the method further includes: sending, by the API producer, another HTTP POST response including a result of the write configuration data operation.

Item [4]: The method according to Item [1], wherein the CM operation is a read configuration data operation, wherein the HTTP request is a HTTP POST request including details for the read configuration data operation including an rApp identifier, and a list of node Ids, and the HTTP response is a HTTP POST response, wherein if the read configuration data operation is synchronous, the HTTP POST Response includes a result of the read configuration data operation, and wherein if the read configuration data operation is asynchronous, the HTTP POST Response includes data related to a read CM job for the read configuration data operation.

Item [5]: The method according to Item [4], wherein if the read configuration data operation is asynchronous, the method further includes: sending, by the API producer, another HTTP POST response including a result of the read configuration data operation.

Item [6]: The method according to Item [1], wherein the CM operation is a read configuration data operation, wherein the HTTP request is a HTTP GET request including details for the read configuration data operation, and the HTTP response is a HTTP GET response including a result of the read configuration data operation, wherein if a single 3GPP node is used for the read configuration data operation, the details for the read configuration data operation include an rApp Identifier, a list of node identifiers (ID's) with a segment of a Uniform Resource Identifier Local Distinguished Name (URI-LDN-first-part), a class name identifier, optional query criteria, and an Open Radio Access Network (O-RAN) resource identifier, wherein if a single O-RAN node is used for the read configuration data operation, the details for the read configuration data operation includes the O-RAN resource ID.

Item [7]: The method according to any one of Items [1]-[5], further including receiving, by the API producer, an HTTP GET request including an rApp Identifier and configuration management (CM) job identifiers (ID's).

Item [8]: An API producer configured to: receive an HTTP request, wherein the HTTP request originates from an API consumer; determine whether the HTTP request is valid based on whether the API consumer is authorized; based on determining that the HTTP request is valid, perform a configuration management (CM) operation based on the HTTP request; and send an HTTP response based on the CM operation and whether the HTTP request is valid.

Item [9]: The API producer according to Item [8], wherein the CM operation is a write configuration data operation, wherein the HTTP request is a HTTP PATCH request comprising details for the write configuration data operation, and wherein the HTTP response is a HTTP PATCH response, wherein if a single 3GPP node is used for the write configuration data operation, the details for the read configuration data operation include an rApp Identifier, a list of node identifiers (ID's) with a segment of a Uniform Resource Identifier Local Distinguished Name (URI-LDN-first-part), a class name identifier, optional query criteria, and an Open Radio Access Network (O-RAN) node identifier, wherein if a single O-RAN node is used for the write configuration data operation, the details for the read configuration data operation includes the O-RAN node ID, wherein if the write configuration data operation is synchronous, the HTTP PATCH Response comprises a result of the write configuration data operation, and wherein if the write configuration data operation is asynchronous, the HTTP PATCH response comprises data related to a write configuration management (CM) job for the write configuration data operation.

Item [10]: The API producer according to Item [9], wherein if the write configuration data operation is asynchronous, the API producer is further configured to: send another HTTP POST response comprising a result of the write configuration data operation.

Item [11]: The API producer according to Item [8], wherein the CM operation is a read configuration data operation, wherein the HTTP request is a HTTP POST request comprising details for the read configuration data operation including an rApp identifier, and a list of node Ids, and the HTTP response is a HTTP POST response, wherein if the read configuration data operation is synchronous, the HTTP POST Response comprises a result of the read configuration data operation, and wherein if the read configuration data operation is asynchronous, the HTTP POST Response comprises data related to a read CM job for the read configuration data operation.

Item [12]: The API producer according to Item [11], wherein if the read configuration data operation is asynchronous, the API producer is further configured to: send another HTTP POST response comprising a result of the read configuration data operation.

Item [13]: The API producer according to Item [8], wherein the CM operation is a read configuration data operation, wherein the HTTP request is a HTTP GET request comprising details for the read configuration data operation, and the HTTP response is a HTTP GET response comprising a result of the read configuration data operation, wherein if a single 3GPP node is used for the read configuration data operation, the details for the read configuration data operation include an rApp Identifier, a list of node identifiers (ID's) with a segment of a Uniform Resource Identifier Local Distinguished Name (URI-LDN-first-part), a class name identifier, optional query criteria, and an Open Radio Access Network (O-RAN) resource identifier, wherein if a single O-RAN node is used for the read configuration data operation, the details for the read configuration data operation includes the O-RAN resource ID.

Item [14]: The API producer according to any one of Items [8]-[12], wherein the API producer is further configured to: receive an HTTP GET request including an rApp Identifier and configuration management (CM) job identifiers (ID's).

Item [15]: At least one non-transitory computer-readable recording medium having recorded thereon instructions executable to implement a method comprising: receiving, by an API producer, an HTTP request, wherein the HTTP request originates from an API consumer; determining, by the API producer, whether the HTTP request is valid based on whether the API consumer is authorized; based on determining that the HTTP request is valid, performing, by the API producer a configuration management (CM) operation based on the HTTP request; and sending, by the API producer, an HTTP response based on the CM operation and whether the HTTP request is valid.

Item [16]: The at least one non-transitory computer-readable recording medium according to Item [15], wherein the CM operation is a write configuration data operation, wherein the HTTP request is a HTTP PATCH request comprising details for the write configuration data operation, and wherein the HTTP response is a HTTP PATCH response, wherein if a single 3GPP node is used for the write configuration data operation, the details for the read configuration data operation include an rApp Identifier, a list of node identifiers (ID's) with a segment of a Uniform Resource Identifier Local Distinguished Name (URI-LDN-first-part), a class name identifier, optional query criteria, and an Open Radio Access Network (O-RAN) node identifier, wherein if a single O-RAN node is used for the write configuration data operation, the details for the read configuration data operation includes the O-RAN node ID, wherein if the write configuration data operation is synchronous, the HTTP PATCH Response comprises a result of the write configuration data operation, and wherein if the write configuration data operation is asynchronous, the HTTP PATCH response comprises data related to a write configuration management (CM) job for the write configuration data operation.

Item [17]: The at least one non-transitory computer-readable recording medium according to Item [16], wherein if the write configuration data operation is asynchronous, the method further comprises: sending, by the API producer, another HTTP POST response comprising a result of the write configuration data operation.

Item [18]: The at least one non-transitory computer-readable recording medium according to Item [15], wherein the CM operation is a read configuration data operation, wherein the HTTP request is a HTTP POST request comprising details for the read configuration data operation including an rApp identifier, and a list of node Ids, and the HTTP response is a HTTP POST response, wherein if the read configuration data operation is synchronous, the HTTP POST Response comprises a result of the read configuration data operation, and wherein if the read configuration data operation is asynchronous, the HTTP POST Response comprises data related to a read CM job for the read configuration data operation, and the method further comprises: sending, by the API producer, another HTTP POST response comprising a result of the read configuration data operation.

Item [19]: The at least one non-transitory computer-readable recording medium according to Item [15], wherein the CM operation is a read configuration data operation, wherein the HTTP request is a HTTP GET request comprising details for the read configuration data operation, and the HTTP response is a HTTP GET response comprising a result of the read configuration data operation, wherein if a single 3GPP node is used for the read configuration data operation, the details for the read configuration data operation include an rApp Identifier, a list of node identifiers (ID's) with a segment of a Uniform Resource Identifier Local Distinguished Name (URI-LDN-first-part), a class name identifier, optional query criteria, and an Open Radio Access Network (O-RAN) resource identifier, wherein if a single O-RAN node is used for the read configuration data operation, the details for the read configuration data operation includes the O-RAN resource ID.

Item [20]: The at least one non-transitory computer-readable recording medium according to any one of Items [15]-[19], further comprising receiving, by the API producer, an HTTP GET request including an rApp Identifier and configuration management (CM) job identifiers (ID's). It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method comprising:
receiving, by an API producer, an HTTP request, wherein the HTTP request originates from an API consumer;
determining, by the API producer, whether the HTTP request is valid based on whether the API consumer is authorized;
based on determining that the HTTP request is valid, performing, by the API producer a configuration management (CM) operation based on the HTTP request; and
sending, by the API producer, an HTTP response based on the CM operation and whether the HTTP request is valid.

2. The method as claimed in claim 1, wherein the CM operation is a write configuration data operation, wherein the HTTP request is a HTTP PATCH request comprising details for the write configuration data operation, and wherein the HTTP response is a HTTP PATCH response,
wherein if a single 3GPP node is used for the write configuration data operation, the details for the read configuration data operation include an rApp Identifier, a list of node identifiers (ID's) with a segment of a Uniform Resource Identifier Local Distinguished Name (URI-LDN-first-part), a class name identifier, optional query criteria, and an Open Radio Access Network (O-RAN) node identifier,
wherein if a single O-RAN node is used for the write configuration data operation, the details for the read configuration data operation includes the O-RAN node ID,
wherein if the write configuration data operation is synchronous, the HTTP PATCH Response comprises a result of the write configuration data operation, and
wherein if the write configuration data operation is asynchronous, the HTTP PATCH response comprises data related to a write configuration management (CM) job for the write configuration data operation.

3. The method as claimed in claim 2, wherein if the write configuration data operation is asynchronous, the method further comprises:
sending, by the API producer, another HTTP POST response comprising a result of the write configuration data operation.

4. The method as claimed in claim 1, wherein the CM operation is a read configuration data operation, wherein the HTTP request is a HTTP POST request comprising details for the read configuration data operation including an rApp identifier, and a list of node Ids, and the HTTP response is a HTTP POST response,
wherein if the read configuration data operation is synchronous, the HTTP POST Response comprises a result of the read configuration data operation, and
wherein if the read configuration data operation is asynchronous, the HTTP POST Response comprises data related to a read CM job for the read configuration data operation.

5. The method as claimed in claim 4, wherein if the read configuration data operation is asynchronous, the method further comprises:
sending, by the API producer, another HTTP POST response comprising a result of the read configuration data operation.

6. The method as claimed in claim 1, wherein the CM operation is a read configuration data operation, wherein the HTTP request is a HTTP GET request comprising details for the read configuration data operation, and the HTTP response is a HTTP GET response comprising a result of the read configuration data operation,
wherein if a single 3GPP node is used for the read configuration data operation, the details for the read configuration data operation include an rApp Identifier, a list of node identifiers (ID's) with a segment of a Uniform Resource Identifier Local Distinguished Name (URI-LDN-first-part), a class name identifier, optional query criteria, and an Open Radio Access Network (O-RAN) resource identifier,
wherein if a single O-RAN node is used for the read configuration data operation, the details for the read configuration data operation includes the O-RAN resource ID.

7. The method as claimed in claim 1, further comprising receiving, by the API producer, an HTTP GET request including an rApp Identifier and configuration management (CM) job identifiers (ID's).

8. An API producer configured to:
receive an HTTP request, wherein the HTTP request originates from an API consumer;
determine whether the HTTP request is valid based on whether the API consumer is authorized;
based on determining that the HTTP request is valid, perform a configuration management (CM) operation based on the HTTP request; and
send an HTTP response based on the CM operation and whether the HTTP request is valid.

9. The API producer as claimed in claim 8, wherein the CM operation is a write configuration data operation, wherein the HTTP request is a HTTP PATCH request comprising details for the write configuration data operation, and wherein the HTTP response is a HTTP PATCH response,
wherein if a single 3GPP node is used for the write configuration data operation, the details for the read configuration data operation include an rApp Identifier, a list of node identifiers (ID's) with a segment of a Uniform Resource Identifier Local Distinguished Name (URI-LDN-first-part), a class name identifier, optional query criteria, and an Open Radio Access Network (O-RAN) node identifier,
wherein if a single O-RAN node is used for the write configuration data operation, the details for the read configuration data operation includes the O-RAN node ID,
wherein if the write configuration data operation is synchronous, the HTTP PATCH Response comprises a result of the write configuration data operation, and
wherein if the write configuration data operation is asynchronous, the HTTP PATCH response comprises data related to a write configuration management (CM) job for the write configuration data operation.

10. The API producer as claimed in claim 9, wherein if the write configuration data operation is asynchronous, the API producer is further configured to:
send another HTTP POST response comprising a result of the write configuration data operation.

11. The API producer as claimed in claim 8, wherein the CM operation is a read configuration data operation, wherein the HTTP request is a HTTP POST request comprising details for the read configuration data operation including an rApp identifier, and a list of node Ids, and the HTTP response is a HTTP POST response,
wherein if the read configuration data operation is synchronous, the HTTP POST Response comprises a result of the read configuration data operation, and
wherein if the read configuration data operation is asynchronous, the HTTP POST Response comprises data related to a read CM job for the read configuration data operation.

12. The API producer as claimed in claim 11, wherein if the read configuration data operation is asynchronous, the API producer is further configured to:
send another HTTP POST response comprising a result of the read configuration data operation.

13. The API producer as claimed in claim 8, wherein the CM operation is a read configuration data operation, wherein the HTTP request is a HTTP GET request comprising details for the read configuration data operation, and the HTTP response is a HTTP GET response comprising a result of the read configuration data operation,
wherein if a single 3GPP node is used for the read configuration data operation, the details for the read configuration data operation include an rApp Identifier, a list of node identifiers (ID's) with a segment of a Uniform Resource Identifier Local Distinguished Name (URI-LDN-first-part), a class name identifier, optional query criteria, and an Open Radio Access Network (O-RAN) resource identifier,
wherein if a single O-RAN node is used for the read configuration data operation, the details for the read configuration data operation includes the O-RAN resource ID.

14. The API producer as claimed in claim 8, wherein the API producer is further configured to: receive an HTTP GET request including an rApp Identifier and configuration management (CM) job identifiers (ID's).

15. At least one non-transitory computer-readable recording medium having recorded thereon instructions executable to implement a method comprising:
receiving, by an API producer, an HTTP request, wherein the HTTP request originates from an API consumer;
determining, by the API producer, whether the HTTP request is valid based on whether the API consumer is authorized;
based on determining that the HTTP request is valid, performing, by the API producer a configuration management (CM) operation based on the HTTP request; and
sending, by the API producer, an HTTP response based on the CM operation and whether the HTTP request is valid.

16. The at least one non-transitory computer-readable recording medium as claimed in claim 15, wherein the CM operation is a write configuration data operation, wherein the HTTP request is a HTTP PATCH request comprising details for the write configuration data operation, and wherein the HTTP response is a HTTP PATCH response,
wherein if a single 3GPP node is used for the write configuration data operation, the details for the read configuration data operation include an rApp Identifier, a list of node identifiers (ID's) with a segment of a Uniform Resource Identifier Local Distinguished Name (URI-LDN-first-part), a class name identifier, optional query criteria, and an Open Radio Access Network (O-RAN) node identifier,
wherein if a single O-RAN node is used for the write configuration data operation, the details for the read configuration data operation includes the O-RAN node ID,
wherein if the write configuration data operation is synchronous, the HTTP PATCH Response comprises a result of the write configuration data operation, and
wherein if the write configuration data operation is asynchronous, the HTTP PATCH response comprises data related to a write configuration management (CM) job for the write configuration data operation.

17. The at least one non-transitory computer-readable recording medium as claimed in claim 16, wherein if the write configuration data operation is asynchronous, the method further comprises:
sending, by the API producer, another HTTP POST response comprising a result of the write configuration data operation.

18. The at least one non-transitory computer-readable recording medium as claimed in claim 15, wherein the CM operation is a read configuration data operation, wherein the HTTP request is a HTTP POST request comprising details for the read configuration data operation including an rApp identifier, and a list of node Ids, and the HTTP response is a HTTP POST response,
wherein if the read configuration data operation is synchronous, the HTTP POST Response comprises a result of the read configuration data operation, and
wherein if the read configuration data operation is asynchronous, the HTTP POST Response comprises data related to a read CM job for the read configuration data operation, and the method further comprises: sending, by the API producer, another HTTP POST response comprising a result of the read configuration data operation.

19. The at least one non-transitory computer-readable recording medium as claimed in claim 15, wherein the CM operation is a read configuration data operation, wherein the HTTP request is a HTTP GET request comprising details for the read configuration data operation, and the HTTP response is a HTTP GET response comprising a result of the read configuration data operation,
wherein if a single 3GPP node is used for the read configuration data operation, the details for the read configuration data operation include an rApp Identifier, a list of node identifiers (ID's) with a segment of a Uniform Resource Identifier Local Distinguished Name (URI-LDN-first-part), a class name identifier, optional query criteria, and an Open Radio Access Network (O-RAN) resource identifier,
wherein if a single O-RAN node is used for the read configuration data operation, the details for the read configuration data operation includes the O-RAN resource ID.

20. The at least one non-transitory computer-readable recording medium as claimed in claim 15, further comprising receiving, by the API producer, an HTTP GET request including an rApp Identifier and configuration management (CM) job identifiers (ID's).
